(19) United States
(12) Patent Application Publication
(10) Pub. No.: US 2025/0299856 A1
(43) Pub. Date: Sep. 25, 2025

(54) MULTILAYER COIL DEVICE

(71) Applicant: TDK Corporation, Tokyo (JP)

(72) Inventors: Keisuke OTSUKA, Tokyo (JP); Takeshi SHIBAYAMA, Tokyo (JP); Hidenobu UMEDA, Tokyo (JP); Yuya OSHIMA, Tokyo (JP); Tsubasa OZAWA, Tokyo (JP); Kaoni SASAKI, Tokyo (JP)

(73) Assignee: TDK Corporation, Tokyo (JP)

(21) Appl. No.: 19/088,199

(22) Filed: Mar. 24, 2025

(30) Foreign Application Priority Data
Mar. 25, 2024 (JP) 2024-048554

(51) Int. Cl. H01F 1/34; H01F 27/24

(52) U.S. Cl. CPC H01F 1/344; H01F 27/24

(57) ABSTRACT

A multilayer coil device includes a magnetic layer. The magnetic layer includes main phases and a grain boundary phase. The main phases include a spinel ferrite. The grain boundary phase includes a silicon oxide and a bismuth oxide. The main phases and the grain boundary phase have an area ratio of 92:8 to 99:1.

### TECHNICAL FIELD

The present invention relates to a multilayer coil device.

### BACKGROUND

In recent years, ferrite chip bead products included in ICT equipment have been increasingly reduced in size along with smaller size of the ICT equipment. While multilayer-type ferrite chip bead products are required to have their interlayer portions thinned for size reduction between electrodes inside the products, insulation not being provided by the interlayer portions causes short circuits. Thus, ferrite materials are required to have smaller grain sizes in order to reduce sizes of pores, which may become portions with a low withstand voltage, and to reduce porosity.

Patent Document 1 discloses a ferrite material that has excellent DC superimposition characteristics by including a NiCuZn based ferrite containing a tin oxide and a potassium oxide and can limit grain sizes of sintered grains to 1.3 μm. However, such a grain size is significantly large for a material for thinned interlayers.

Patent Document 2 discloses a ferrite material having a mixing ratio of a magnetic material to a non-magnetic material of 20 wt %:80 wt % to 80 wt %:20 wt % to improve density and permeability. However, as the proportion of the non-magnetic material increases, a magnetic path is divided to reduce permeability.
Patent Document 1: JP Patent Application Laid Open No. 2011-213578
Patent Document 2: JP Patent Application Laid Open No. 2014-220469

### SUMMARY

It is an object of the present invention to provide a multilayer coil device with high permeability and excellent withstand voltage characteristics.

To achieve the above object, a multilayer coil device according to one aspect of the present invention is
a multilayer coil device including a magnetic layer,
wherein
the magnetic layer includes main phases and a grain boundary phase, the main phases including a spinel ferrite, the grain boundary phase including a silicon oxide and a bismuth oxide; and
the main phases and the grain boundary phase have an area ratio of 92:8 to 99:1.

This multilayer coil device has improved permeability and improved withstand voltage characteristics.

Preferably, the magnetic layer includes a ferrite composition including a main component and a subcomponent. The main component includes preferably 24.0 to 50.0 mol % or more preferably 26.0 to 49.8 mol % iron oxide in terms of Fe₂O₃, preferably 2.2 to 12.0 mol % or more preferably 5.0 to 10.0 mol % copper oxide in terms of CuO, preferably 12.3 to 39.0 mol % or more preferably 13.0 to 37.9 mol % zinc oxide in terms of ZnO, and a nickel oxide as a remainder. The subcomponent includes preferably 0.02 to 3.0 parts by weight or more preferably 0.10 to 2.0 parts by weight bismuth oxide in terms of Bi₂O₃ with respect to 100 parts by weight of the main component.

The subcomponent may further include a silicon oxide. The subcomponent includes preferably 0.02 to 3.0 parts by weight, more preferably 0.1 to 3.0 parts by weight, or still more preferably 0.1 to 2.0 parts by weight silicon oxide in terms of SiO₂ with respect to 100 parts by weight of the main component.

The subcomponent may further include a cobalt oxide. The subcomponent includes preferably 0.1 to 4.0 parts by weight or more preferably 0.1 to 3.0 parts by weight cobalt oxide in terms of Co₃O₄ with respect to 100 parts by weight of the main component.

The subcomponent may further include a silver oxide. The subcomponent includes preferably 0.02 to 3.2 parts by weight, more preferably 0.02 to 3.0 parts by weight, or still more preferably 0.1 to 3.0 parts by weight silver oxide in terms of Ag₂O with respect to 100 parts by weight of the main component.

The main phases have an average grain size of preferably 0.27 to 0.6 μm or more preferably 0.27 to 0.5 μm.

### BRIEF DESCRIPTION OF THE DRAWING(S)

FIG. 1A is a transparent perspective view of a multilayer coil device according to one embodiment of the present invention.

FIG. 1B is a transparent perspective view of a multilayer coil device according to another embodiment of the present invention.

FIG. 2 is a schematic view of a sectional SEM image of a magnetic layer of the multilayer coil device shown in FIG. 1A.

FIG. 3 is an elemental mapping photograph, obtained using STEM-EDS, of a section of a magnetic layer of a multilayer coil device according to an example of the present invention.

### DETAILED DESCRIPTION

Hereinafter, embodiments are described.

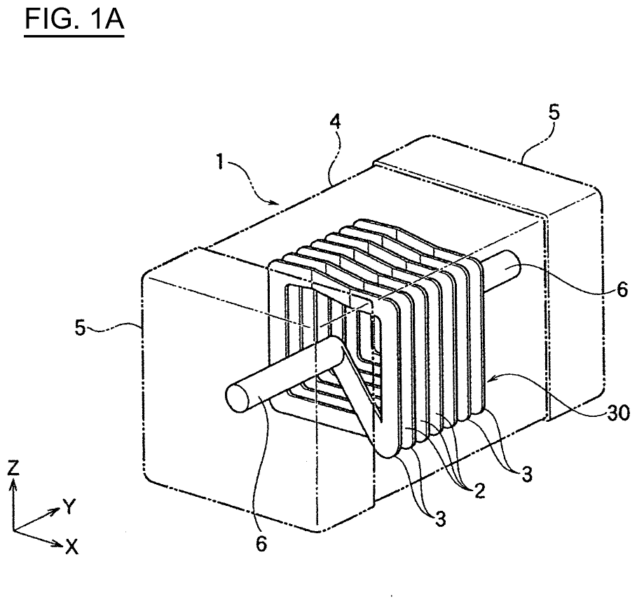

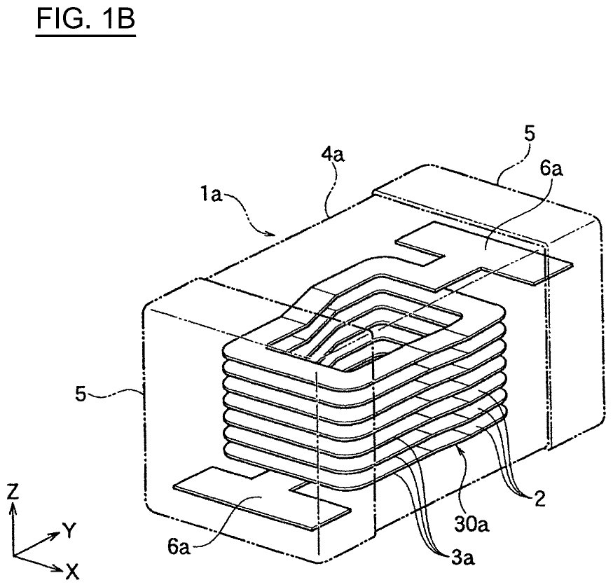

As shown in FIG. 1A, a multilayer chip coil 1 as a multilayer coil device according to one embodiment of the present invention includes a chip body 4, in which magnetic layers (ceramic layers) 2 and internal electrode layers 3 are alternately laminated in the Y-axis direction.

The internal electrode layers 3 have a rectangular ring shape, a C shape, or a U shape and are spirally connected using an internal electrode connecting through-hole electrode (not shown in the drawings) penetrating the adjacent magnetic layers 2 or a stepped electrode, constituting a coil conductor 30.

On both ends of the chip body 4 in the Y-axis direction, respective terminal electrodes 5 and 5 are provided. Each of the terminal electrodes 5 is connected to an end of a corresponding terminal connecting through-hole electrode 6 penetrating the laminated magnetic layers 2. The terminal electrodes 5 and 5 are connected to respective ends of the coil conductor 30 constituting a closed magnetic circuit coil (winding wire pattern).

In the present embodiment, the direction along which the magnetic layers 2 and the internal electrode layers 3 are laminated corresponds to the Y-axis; and end surfaces of the terminal electrodes 5 and 5 are parallel to the X-axis and the Z-axis. The X-axis, the Y-axis, and the Z-axis are perpendicular to each other. In the multilayer chip coil 1 shown in FIG. 1A, the winding axis of the coil conductor 30 substantially corresponds to the Y-axis.

The chip body 4 may have any external shape or dimensions. The external shape or dimensions can be appropriately determined according to usage. The chip body 4 normally has a substantially rectangular parallelepiped shape and has a dimension of, for example, 0.125 to 0.8 mm in the X-axis direction, 0.25 to 1.6 mm in the Y-axis direction, and 0.1 to 1.0 mm in the Z-axis direction.

The magnetic layers 2 may have any inter-electrode thickness and any base thickness. The inter-electrode thickness (distance between the internal electrode layers 3 and 3) can be about 2.5 to 50 μm. The base thickness (length of the terminal connecting through-hole electrode 6 in the Y-axis direction) can be about 5 to 300 μm. However, in the present embodiment, even with the inter-electrode thickness of the magnetic layers 2 being as thin as about 2.0 μm or less, a multilayer coil device with high permeability and excellent withstand voltage characteristics can be achieved.

In the present embodiment, the terminal electrodes 5 are not limited. They are formed by applying a conductive paste having Ag, Pd, or the like as a main component to outer surfaces of the chip body 4, baking the applied paste, and further carrying out electroplating. For electroplating, Cu, Ni, Sn, or the like can be used.

The coil conductor 30 contains Ag (including a Ag alloy) and is composed of, for example, a simple substance of Ag or a Ag—Pd alloy. The coil conductor 30 can contain, as a subcomponent, Zr, Fe, Mn, Ti, and their oxides.

The magnetic layers 2 are composed of a ferrite composition including a main component and a subcomponent. Hereinafter, the ferrite composition is described in detail.

The main component includes an iron oxide, a copper oxide, a zinc oxide, and a nickel oxide.

Out of 100 mol % main component, the iron oxide content is preferably 24.0 mol % or more or more preferably 26.0 mol % or more and is preferably 50.0 mol % or less or more preferably 49.8 mol % or less, in terms of Fe₂O₃. Too low an iron oxide content tends to reduce initial permeability. Too high an iron oxide content tends to impair temperature characteristics of permeability.

Out of 100 mol % main component, the copper oxide content is preferably 2.2 mol % or more or more preferably 5.0 mol % or more and is preferably 12.0 mol % or less or more preferably 10.0 mol % or less, in terms of CuO. Too low a copper oxide content tends to reduce density, specific resistance, and also initial permeability. This may be because of impaired sinterability. Too high a copper oxide content tends to reduce initial permeability or specific resistance. This may be because of segregation of the copper oxide.

Out of 100 mol % main component, the zinc oxide content is preferably 12.3 mol % or more or more preferably 13.0 mol % or more and is preferably 39.0 mol % or less or more preferably 37.9 mol % or less, in terms of ZnO. Too low a zinc oxide content tends to reduce specific resistance and withstand voltage characteristics (breakdown voltage value). Too high a zinc oxide content tends to reduce specific resistance and initial permeability.

The remainder of the main component is composed of the nickel oxide. The nickel oxide content of the main component is not limited and is, for example, 47.0 to 47.5 mol % in terms of NiO.

The magnetic layers 2 contain, in addition to the above main component, the subcomponent including at least a bismuth oxide and a silicon oxide.

With respect to 100 parts by weight main component, the bismuth oxide content is preferably 0.02 parts by weight or more or more preferably 0.10 parts by weight or more and is preferably 3.0 parts by weight or less or more preferably 2.0 parts by weight or less, in terms of Bi₂O₃. Too low a bismuth oxide content tends to reduce initial permeability or specific resistance. This may be because of impaired sinterability. Too high a bismuth oxide content tends to reduce specific resistance. This may be because of abnormal grain growth of bismuth.

With respect to 100 parts by weight main component, the silicon oxide content is preferably 0.02 parts by weight or more or more preferably 0.10 parts by weight or more and may be preferably 3.0 parts by weight or less, more preferably 2.30 parts by weight or less, or 2.00 parts by weight or less, in terms of SiO₂. The silicon oxide can reduce the average grain size and improve specific resistance and withstand voltage. However, too high a silicon oxide content tends to reduce density and specific resistance. This may be because of impaired sinterability.

The magnetic layers 2 may further contain a cobalt oxide separately from the above components. The cobalt oxide content is not limited. With respect to 100 parts by weight main component, the cobalt oxide content is preferably 0.1 parts by weight or more and is preferably 4.0 parts by weight or less or more preferably 3.0 parts by weight or less, in terms of Co₃O₄. The cobalt oxide improves density, specific resistance, and withstand voltage characteristics. However, too high a cobalt oxide content tends to reduce density, initial permeability, and specific resistance.

The magnetic layers 2 may further contain a silver oxide separately from the above components. The silver oxide content is not limited. With respect to 100 parts by weight main component, the silver oxide content is preferably 0.02 parts by weight or more or more preferably 0.1 parts by weight or more and is preferably 3.2 parts by weight or less or more preferably 3.0 parts by weight or less, in terms of Ag₂O. The silver oxide improves density, reduces porosity, and improves withstand voltage characteristics. However, too high a silver oxide content tends to reduce initial permeability and specific resistance.

The magnetic layers 2 may further contain additional components, such as a manganese oxide (Mn₃O₄), a zirconium oxide, a magnesium oxide, and a glass compound, separately from the above components. The additional component content is not limited as long as effects of the present embodiment are not hindered and is, for example, 1 part by weight or less.

The magnetic layers 2 may further contain oxides of inevitable impurity elements. Specifically, examples of inevitable impurity elements include C, S, Cl, As, Se, Br, Te, I, typical metal elements (e.g., Li, Na, Mg, Al, Ca, Ga, Ge, Sr, Cd, In, Sb, Ba, and Pb), and transition metal elements (e.g., Sc, Ti, V, Cr, Y, Nb, Mo, Pd, Hf, and Ta). The magnetic layers 2 preferably contain about 0.05 parts by weight or less oxides of inevitable impurity elements.

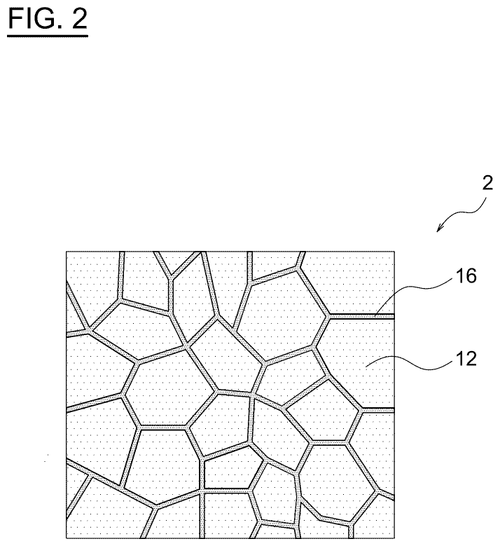

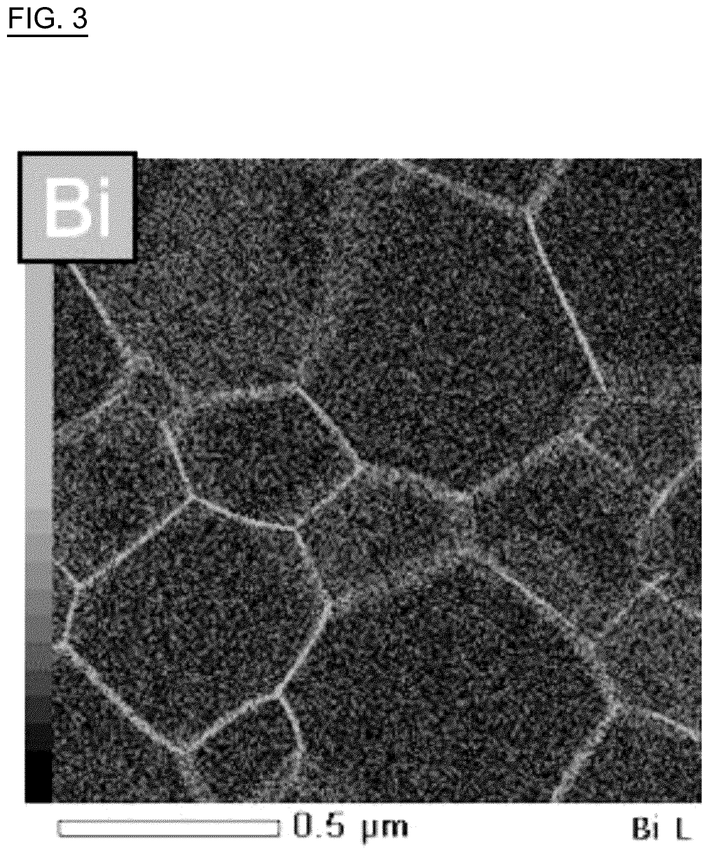

In a section of the magnetic layers 2 having the above composition, as shown in FIG. 2, the magnetic layers 2 include main phases 12, which are composed of a spinel ferrite, and a grain boundary phase 16, which contains the silicon oxide and the bismuth oxide. FIG. 3 is a Bi elemental mapping image of the magnetic layers 2 obtained using STEM-EDS at a magnification of ×100000.

The main phases 12 are mainly composed of the main component having the above composition. The grain boundary phase 16 is a phase containing at least the silicon oxide and the bismuth oxide. As shown in FIG. 3, it can be confirmed, during observation of a Bi distribution in a section of the magnetic layers 2, that the Bi concentration is higher at the location of the grain boundary phase 16 shown in FIG. 2 than at the locations of the main phases 12, and that the grain boundary phase 16 contains the bismuth oxide, with FIG. 3 being combined with an oxygen mapping image.

Similarly, it can be confirmed, during observation of a Si distribution in a section of the magnetic layers 2, that the Si concentration is higher at the location of the grain boundary phase 16 shown in FIG. 2 than at the locations of the main phases 12, and that the grain boundary phase 16 contains the silicon oxide, with a Si mapping image being combined with the oxygen mapping image. Note that, at the grain boundary phase 16, a complex oxide of the bismuth oxide and the silicon oxide may be formed.

The grain boundary phase 16 may contain elements other than bismuth and silicon. However, out of 100 mol % (amount by mole) elements other than oxygen contained in the grain boundary phase 16, bismuth and silicon account for a total of 6.50 mol % or more; and it may be that no other elements are contained. Alternatively, out of 100 mol % (amount by mole) elements other than oxygen contained in the grain boundary phase, the elements other than bismuth and silicon may account for 96.0 mol % or less. Examples of elements that may be contained in the grain boundary phase other than oxygen include the constituent elements of the main component or the subcomponent described earlier, the additional components, or the inevitable impurities.

In the grain boundary phase 16, the mole ratio of bismuth to silicon is not limited and may be 1.00:0.05 to 1.00:0.59.

Although not shown in FIG. 2, the magnetic layers 2 may have pores. The porosity, or the ratio of the area of pores to the area of a field of view of a section of the magnetic layers 2 observed, is preferably smaller. Preferred porosities are, for example, 7.3% or less, 9% or less, or 12% or less in the order mentioned.

In the present embodiment, the main phases 12 and the grain boundary phase 16 have an area ratio of preferably 92:8 to 99:1 or more preferably 93:7 to 98:2, provided that the total area of the main phases 12 and the grain boundary phase 16, pores being excluded, in a STEM-EDS image of the magnetic layers 2 at a magnification of, for example, ×20000 or more, at which the main phases 12 are visible, is 100%. Such a structure enables the multilayer chip coil 1 to have excellent withstand voltage characteristics while having high permeability maintained.

The main phases 12 in the magnetic layers 2 have an average grain size of preferably 0.27 to 0.6 μm or more preferably 0.27 to 0.5 μm. Any method of measuring the average grain size may be used. Examples of such methods include a method of measurement in a section of the magnetic layers 2 using an electron microscope (e.g., a SEM or a STEM) and a method of measurement using XRD.

Next, a method of manufacturing the multilayer chip coil 1 according to the present embodiment is described. First, starting raw materials (raw materials of the main component and raw materials of the subcomponent) are weighed to have a predetermined composition ratio. Starting raw materials having an average particle size of 0.05 to 3.00 μm are preferably used.

As the raw materials of the main component, for example, an iron oxide (α-Fe₂O₃), a copper oxide (CuO), a nickel oxide (NiO), a zinc oxide (ZnO), or a complex oxide can be used. Examples of complex oxides include zinc silicate (Zn₂SiO₄). Moreover, various compounds or the like that become the above oxides or complex oxides by firing can be used. Examples of materials that become the above oxides by firing include metal simple substances, carbonates, oxalates, nitrates, hydroxides, halides, and organometallic compounds.

As the raw materials of the subcomponent, a silicon oxide, a bismuth oxide, a cobalt oxide, and a silver oxide can be used. Any oxides may be used as the raw materials of the subcomponent. For example, complex oxides can be used. Examples of complex oxides include zinc silicate (Zn₂SiO₄). Moreover, various compounds or the like that become the above oxides or complex oxides by firing can be used. Examples of materials that become the above oxides by firing include metal simple substances, carbonates, oxalates, nitrates, hydroxides, halides, and organometallic compounds.

Note that Co₃O₄, which is one form of cobalt oxides, is preferred as a raw material of the cobalt compound due to being easily stored or handled and having a stable valence even in air.

Then, the iron oxide, the copper oxide, the nickel oxide, and the zinc oxide, which are the raw materials of the main component, are mixed to give a raw material mixture. It may be that, among the above raw materials of the main component, the zinc oxide is not added at this stage; and the zinc oxide may be added together with zinc silicate to the raw material mixture after it is calcined. In contrast, some of the raw materials of the subcomponent may be mixed with the raw materials of the main component at this stage. Appropriately controlling the types or the proportions of the raw materials in the raw material mixture can control the existence ratio of the main phases to the grain boundary phase.

Specifically, the lower the ZnO content of the raw material mixture, the larger the area ratio of the grain boundary phase tends to be. Any mixing method may be used. Examples of mixing methods include wet-mixing using a ball mill and dry-mixing using a dry mixer.

Then, the raw material mixture is calcined to give a calcined material. Calcination causes thermal decomposition of the raw materials, homogenization of the components, generation of a ferrite, and disappearance of an ultrafine powder and grain growth to appropriate grain size through sintering. Calcination is carried out for conversion of the raw material mixture into a form suitable for subsequent steps. There is no limit to the calcination time or the calcination temperature. Calcination is normally carried out in the atmosphere (air) but may be carried out in an atmosphere having a lower oxygen partial pressure than that of the atmosphere.

Then, the calcined material is mixed with the silicon oxide, the bismuth oxide, the cobalt oxide, the silver oxide, zinc silicate, and the like, which are the raw materials of the subcomponent, to give a mixed calcined material. The more Bi in the mixed calcined material, the larger the existence ratio (area ratio) of the grain boundary phase tends to be. It is assumed that bismuth flows into the grain boundary phase during sintering to form a bismuth oxide in the grain boundary phase and that the grain boundary phase at a predetermined area ratio restrains grain growth during firing to improve withstand voltage characteristics and permeability. It is assumed that silicon also has an effect similar to that of bismuth.

Then, the mixed calcined material is pulverized to give a pulverized calcined material. Pulverization is carried out for crushing the agglomeration of the mixed calcined material and turning it into a powder having an appropriate sinterability. When the mixed calcined material constitutes a large lump, rough pulverization is carried out, and then wet pulverization is carried out using a ball mill, an attritor, or the like. Wet pulverization is carried out until the pulverized calcined material has an average particle size of preferably about 0.1 μm to about 3.00 μm.

A method of manufacturing the multilayer chip coil 1, in which the above wet-pulverized material is used, shown in FIG. 1A is described below.

The multilayer chip coil 1 shown in FIG. 1A can be manufactured using a typical manufacturing method. That is, the chip body 4 can be formed in such a manner that a ferrite paste obtained by kneading the pulverized calcined material with a binder and a solvent and an internal electrode paste containing Ag or the like are alternately printed, laminated, and then fired (printing method). Alternatively, the chip body 4 may be formed in such a manner that green sheets are formed using the ferrite paste, the internal electrode paste is printed on surfaces of the green sheets, and such green sheets are laminated and fired (sheet method). In any event, after the chip body is formed, the terminal electrodes 5 are formed by baking, plating, or the like.

The binder content and the solvent content of the ferrite paste are not limited. Out of 100 wt % ferrite paste as a whole, for example, the binder content can be about 1 wt % to about 10 wt %, and the solvent content can be about 10 wt % to about 50 wt %. The ferrite paste can contain 10 wt % or less dispersants, plasticizers, dielectrics, insulators, or the like as necessary. The internal electrode paste containing Ag or the like can be prepared in a similar manner. While firing conditions and the like are not limited, the firing temperature is preferably 930° C. or less or is more preferably 900° C. or less when the internal electrode layers contain Ag or the like.

The present invention is not limited to the above embodiment and can variously be modified within the scope of the present invention.

For example, structures of the multilayer coil device are not limited to those shown in FIG. 1A and may include, for example, those of a multilayer chip coil 1a shown in FIG. 1B. This coil 1a includes a chip body 4a, in which magnetic layers 2 and internal electrode layers 3a are alternately laminated in the Z-axis direction. These magnetic layers 2 have a structure similar to that of the magnetic layers 2 of the embodiment described above.

The internal electrode layers 3a have a rectangular ring shape, a C shape, or a U shape and are spirally connected using an internal electrode connecting through-hole electrode (not shown in the drawings) penetrating the adjacent magnetic layers 2 or a stepped electrode, constituting a coil conductor 30a.

On both ends of the chip body 4a in the Y-axis direction, respective terminal electrodes 5 and 5 are provided. The terminal electrodes 5 are connected to respective ends of leading electrodes 6a located at the top and bottom in the Z-axis direction and are thereby connected to respective ends of the coil conductor 30a constituting a closed magnetic circuit coil.

In the present embodiment, the direction along which the magnetic layers 2 and the internal electrode layers 3a are laminated corresponds to the Z-axis; and end surfaces of the terminal electrodes 5 and 5 are parallel to the X-axis and the Z-axis. The X-axis, the Y-axis, and the Z-axis are perpendicular to each other. In the multilayer chip coil 1a shown in FIG. 1B, the winding axis of the coil conductor 30a substantially corresponds to the Z-axis.

The multilayer chip coil 1 shown in FIG. 1A is more advantageous than the multilayer chip coil 1a shown in FIG. 1B in that the number of windings can be increased to readily achieve high impedance up to a high frequency band, because the winding axis of the coil conductor 30 corresponds to the Y-axis direction, which is the longitudinal direction of the chip body 4. Other structures and effects of the multilayer chip coil 1a shown in FIG. 1B are similar to those of the multilayer chip coil 1 shown in FIG. 1A.

Multilayer coil devices of the present embodiment may be any devices that partly include a portion having the magnetic layers 2 described above. Such multilayer coil devices include multilayer complex electronic devices in which elements, such as a coil and a capacitor, are combined.

The multilayer coil devices of the present embodiment may be used for any purpose. The multilayer coil devices are suitably included in circuits (e.g., circuits of ICT devices, such as smartphones, incorporating NFC technology, contact-free charging, etc.) in which a winding-type ferrite inductor has been conventionally used particularly due to a high alternating current flowing.

### EXAMPLES

Hereinafter, more detailed examples are described; however, the present invention is not limited to these examples.

### Examples 1 to 5

First, as raw materials of a main component, an Fe₂O₃ powder, a NiO powder, a CuO powder, and a ZnO powder were prepared. As raw materials of a subcomponent, a SiO₂ powder, a Bi₂O₃ powder, a Co₃O₄ powder, and a Ag₂O powder were prepared. The SiO₂ powder had a raw material average particle size of 0.025 μm. The prepared raw materials of the main component and the subcomponent were weighed to give a composition shown in Table 1. Then, the raw materials of the main component were wet-mixed using a ball mill for 24 hours to give a raw material mixture.

The resultant raw material mixture was dried and was then calcined in air at 720° C. for 10 hours to give a calcined material. Then, to the calcined material, the raw materials of the subcomponent, which were the SiO₂ powder, the Bi₂O₃ powder, the Co₃O₄ powder, and the Ag₂O powder, were added; and this mixture was wet-pulverized using a ball mill for 16 hours to give a pulverized material.

This pulverized material was dried. Then, to 100 parts by weight pulverized material, 10.0 parts by weight polyvinyl alcohol as a binder was added for granulation to give granules. These granules were pressure-molded to give toroidal shaped (dimensions=outside diameter 13 mm×inside diameter 6 mm×height 3 mm) and disk-shaped (dimensions=outside diameter 12 mm×height 2 mm) molded bodies with an intended molding density of 3.2 Mg/m³.

These molded bodies were fired in air at 880° C. to 980° C. for 2 hours to give toroidal core samples and disk-shaped samples as sintered bodies. The resultant samples were subject to the following characteristic evaluation. Note that, using an X-ray fluorescence analysis apparatus, it was confirmed that almost nothing changed between the compositions of the weighed raw material powders and the fired molded bodies.

### <Area Ratio of Main Phases to Grain Boundary Phase>

A section (corresponding to a section of magnetic layers 2) of the toroidal core samples was observed using an EPMA and STEM-EDS. The observation magnification was ×20000 or more and was appropriately determined for each Example or each Comparative Example. It was confirmed that main phases composed of spinel ferrite phases, a grain boundary phase containing a silicon oxide and a bismuth oxide, and pores were observed in the section. Moreover, from the results of observation using STEM-EDS, the area ratio of the main phases to the grain boundary phase in a field of view was calculated. Table 1 shows the results. FIG. 3 is a Bi elemental mapping photograph, obtained using STEM-EDS, of a section of a sample of Example 3.

### <Porosity and Average Grain Size>

The toroidal core samples were cut, and an at least 100 μm²-region of the resultant section was observed using a scanning electron microscope (SEM) to take a SEM photograph. This SEM photograph was subject to image processing using software. Using an EDS analysis as well, the main phases, the grain boundary phase, and the pores were extracted, and their areas were calculated. The ratio of the calculated area of the pores to the total calculated area of the main phases and the grain boundary phase was defined as porosity. Equivalent circle diameters (Heywood diameters) of the respective main phases were calculated, and their number average was defined as the average grain size. Table 1 shows the results.

### <Density>

The densities of the toroidal core samples were calculated from their dimensions and weights. Table 1 shows the results.

<Initial Permeability μi>

Around the toroidal core samples, a copper wire was wound for ten turns. Using an impedance analyzer (4991A manufactured by Agilent Technologies, Inc.), initial permeability μi was measured. As for measurement conditions, the measurement frequency was 1 MHz, and the measurement temperature was 25° C. In the present examples, an initial permeability of 35 or more was defined as good, and an initial permeability of 40 or more was defined as better. Table 1 shows the results.

### <Rate of Change of Permeability According to Temperature>

Additionally, the rate of change of permeability of these samples according to temperature was evaluated. Specifically, permeability at 125° C. was measured. Then, the rate of change (%) with respect to permeability (initial permeability μi) at a reference temperature of 25° C. was calculated. In the present examples, a rate of change according to temperature of 27% or less was defined as good. Table 1 shows the results.

### <Specific Resistance ρ>

An In—Ga electrode was applied to both surfaces of the disk-shaped samples. DC resistance was measured, and specific resistance p was found (unit: Ω·m). For measurement, an IR meter (4329A manufactured by HEWLETT PACKARD) was used. In the present examples, a specific resistance ρ of 1.0×10⁶ Ω·m or more (1.0E+06 Ω·m or more) was defined as good. Table 1 shows the results.

### <Withstand Voltage (Breakdown Voltage Value)>

Using the pulverized material same as that of the toroidal core samples described above, capacitor samples were manufactured. Specifically, green multilayer bodies for forming capacitor circuits were manufactured using a printing method so that conductor layers after firing had a thickness of 0.7 μm, ceramic layers (magnetic layers) after firing had a thickness of 5 μm, and the number of the conductor layers was three. As a raw material of the conductor, Ag particles were used. The green multilayer bodies were fired in air at 860° C. to 900° C. for 2 hours to give fired chips having a rectangular parallelepiped shape measuring 1.6 mm×0.8 mm×0.8 mm. To both end surfaces of each resultant fired chip, an In—Ga terminal electrode paste was applied. The applied paste was dried. Then, a baking treatment was carried out in an atmosphere with an oxygen partial pressure of 1% at 700° C. for 1 hour.

Then, electroplating was carried out to form a Ni plating layer and a Sn plating layer on terminal electrodes to give the capacitor samples having the terminal electrodes. The capacitor samples were subject to the following withstand voltage evaluation.

Using at least five capacitor samples, what direct voltage increasingly applied at 10 V per second to the samples resulted in a leakage current of 10 mA was measured, and this voltage value was divided by the inter-conductor thickness. The average of such quotients was defined as breakdown voltage (withstand voltage). A withstand voltage of 16 V/μm or more was defined as good, and a withstand voltage of 20 V/μm or more was defined as better. Table 1 shows the results.

TABLE 1

| | | | | | | | | | | Area | |
|---|---|---|---|---|---|---|---|---|---|---|---|
| | | | | | | | | | Average | ratio [%] | |
| | Main component | | | | Subcomponent | | | | grain | | Grain |
| | [mol %] | | | | [parts by weight] | | | | size | Main | boundary |
| | Fe₂O₃ | NiO | CuO | ZnO | SiO₂ | Bi₂O₃ | Co₃O₄ | Ag₂O | [μm] | phase | phase |
| Comparative | 48.0 | 23.5 | 8.2 | 20.3 | 2.00 | 3.00 | 0.75 | 0.10 | 0.31 | 91 | 9 |
| Example 1 | | | | | | | | | | | |
| Example 1 | 48.0 | 23.5 | 8.2 | 20.3 | 1.00 | 2.00 | 0.75 | 0.10 | 0.33 | 92 | 8 |
| Example 2 | 48.0 | 23.5 | 8.2 | 20.3 | 0.24 | 0.75 | 0.75 | 0.10 | 0.37 | 94 | 6 |
| Example 3 | 48.0 | 23.5 | 8.2 | 20.3 | 0.24 | 0.50 | 0.75 | 0.10 | 0.40 | 96 | 4 |
| Example 4 | 48.0 | 23.5 | 8.2 | 20.3 | 0.24 | 0.25 | 0.75 | 0.10 | 0.46 | 98 | 2 |
| Example 5 | 48.0 | 23.5 | 8.2 | 20.3 | 0.24 | 0.10 | 0.75 | 0.10 | 0.48 | 99 | 1 |
| Comparative | 48.0 | 23.5 | 8.2 | 20.3 | 0.10 | 0.02 | 0.75 | 0.10 | 0.52 | 99.5 | 0.5 |
| Example 2 | | | | | | | | | | | |

| | | | | Rate of change | | | |
|---|---|---|---|---|---|---|---|
| | | | | of permeability | | | |
| | | | | according to | Breakdown | Specific | Firing |
| | Density | Porosity | | temperature | voltage | resistance | temperature |
| | [g/cm³] | [%] | Permeability | [%] | [V/μm] | [Ω · m] | [° C.] |
| Comparative | 5.16 | 6.25 | 25.6 | 21.93 | 25.58 | 1.38E+06 | 880 |
| Example 1 | | | | | | | |
| Example 1 | 5.21 | 6.25 | 40.9 | 22.24 | 24.89 | 3.29E+06 | 880 |
| Example 2 | 5.17 | 6.62 | 43.7 | 22.94 | 22.15 | 2.92E+06 | 900 |
| Example 3 | 5.05 | 5.13 | 45.2 | 22.87 | 24.26 | 1.40E+06 | 900 |
| Example 4 | 5.04 | 7.15 | 48.1 | 22.94 | 23.16 | 1.39E+06 | 900 |
| Example 5 | 4.94 | 5.94 | 55.2 | 22.12 | 24.09 | 5.12E+06 | 900 |
| Comparative | 5.02 | 7.15 | 29.6 | 22.91 | 19.48 | 1.24E+06 | 940 |
| Example 2 | | | | | | | |

### Comparative Examples 1 and 2

Toroidal core samples, disk-shaped samples, and capacitor samples were manufactured as in Example 1 except that the raw materials of the subcomponent were controlled so that the ratio of the Bi₂O₃ powder to the SiO₂ powder was as shown in Table 1. Evaluation was conducted as in Example 1. Table 1 shows the results.

### Evaluation 1

According to the results shown in Table 1, it was confirmed that, in Examples 1 to 5, in which the area ratio of the main phases to the grain boundary phase in the magnetic layers satisfied a predetermined range, permeability and withstand voltage characteristics were better than those of Comparative Examples 1 and 2. It was also confirmed that, 0.02 to 3.0 parts by weight or more preferably 0.10 to 2.0 parts by weight bismuth oxide in terms of Bi₂O₃ with respect to 100 parts by weight main component improved permeability and withstand voltage characteristics.

### Examples 6 to 10

Samples were manufactured as in Example 1 except that the mixing ratio of the raw materials was controlled so that the proportion of SiO₂ in the subcomponent was as shown in Table 2. The resultant samples were subject to evaluation as in Example 1. Table 2 shows the results.

TABLE 2

| | | | | | | | | | | Area | |
|---|---|---|---|---|---|---|---|---|---|---|---|
| | | | | | | | | | Average | ratio [%] | |
| | Main component | | | | Subcomponent | | | | grain | | Grain |
| | [mol %] | | | | [parts by weight] | | | | size | Main | boundary |
| | Fe₂O₃ | NiO | CuO | ZnO | SiO₂ | Bi₂O₃ | Co₃O₄ | Ag₂O | [μm] | phase | phase |
| Example 6 | 48.0 | 23.5 | 8.2 | 20.3 | 3.00 | 2.00 | 0.75 | 0.10 | 0.26 | 95 | 5 |
| Example 7 | 48.0 | 23.5 | 8.2 | 20.3 | 2.00 | 2.00 | 0.75 | 0.10 | 0.27 | 95 | 5 |
| Example 8 | 48.0 | 23.5 | 8.2 | 20.3 | 0.85 | 2.00 | 0.75 | 0.10 | 0.34 | 95 | 5 |
| Example 9 | 48.0 | 23.5 | 8.2 | 20.3 | 0.65 | 2.00 | 0.75 | 0.10 | 0.50 | 95 | 5 |
| Example 10 | 48.0 | 23.5 | 8.2 | 20.3 | 0.50 | 2.00 | 0.75 | 0.10 | 0.60 | 95 | 5 |

| | | | | Breakdown | Specific | Firing |
|---|---|---|---|---|---|---|
| | Density | Porosity | | voltage | resistance | temperature |
| | [g/cm³] | [%] | Permeability | [V/μm] | [Ω · m] | [° C.] |
| Example 6 | 5.01 | 6.25 | 35.1 | 27.14 | 6.24E+04 | 900 |
| Example 7 | 5.12 | 6.25 | 40.3 | 25.66 | 4.31E+06 | 900 |
| Example 8 | 5.20 | 6.62 | 41.3 | 23.83 | 3.43E+06 | 900 |
| Example 9 | 5.18 | 5.94 | 41.9 | 21.13 | 4.21E+06 | 900 |
| Example 10 | 5.14 | 7.15 | 47.3 | 17.18 | 3.82E+04 | 900 |

### Evaluation 2

According to the results shown in Table 2, it was found that controlling the proportion of SiO₂ changed the average grain size and that, when the average grain size of the main phases was within a predetermined range, the area ratio of the main phases to the grain boundary phase satisfied the predetermined range, which improved permeability and withstand voltage characteristics. It was also confirmed that an average grain size of 0.27 to 0.6 μm or more preferably 0.27 to 0.5 μm improved permeability and withstand voltage characteristics.

### Examples 11 to 15

Samples were manufactured as in Example 3 except that the mixing ratio of the raw materials was controlled so that the proportions of the raw materials of the main component were as shown in Table 3. The resultant samples were subject to evaluation as in Example 1. Table 3 shows the results.

TABLE 3

| | | | | | | | | | | Area | |
|---|---|---|---|---|---|---|---|---|---|---|---|
| | | | | | | | | | Average | ratio [%] | |
| | Main component | | | | Subcomponent | | | | grain | | Grain |
| | [mol %] | | | | [parts by weight] | | | | size | Main | boundary |
| | Fe₂O₃ | NiO | CuO | ZnO | SiO₂ | Bi₂O₃ | Co₃O₄ | Ag₂O | [μm] | phase | phase |
| Example 11 | 24.0 | 47.5 | 8.2 | 20.3 | 0.24 | 0.50 | 0.75 | 0.10 | 0.44 | 96 | 4 |
| Example 12 | 26.0 | 45.5 | 8.2 | 20.3 | 0.24 | 0.50 | 0.75 | 0.10 | 0.42 | 96 | 4 |
| Example 13 | 37.0 | 34.5 | 8.2 | 20.3 | 0.24 | 0.50 | 0.75 | 0.10 | 0.41 | 96 | 4 |
| Example 3 | 48.0 | 23.5 | 8.2 | 20.3 | 0.24 | 0.50 | 0.75 | 0.10 | 0.40 | 96 | 4 |
| Example 14 | 49.8 | 21.7 | 8.2 | 20.3 | 0.24 | 0.50 | 0.75 | 0.10 | 0.42 | 96 | 4 |
| Example 15 | 50.0 | 21.5 | 8.2 | 20.3 | 0.24 | 0.50 | 0.75 | 0.10 | 0.40 | 96 | 4 |

| | | | | Rate of change | | |
|---|---|---|---|---|---|---|
| | | | | of permeability | | |
| | | | | according to | Breakdown | Firing |
| | Density | Porosity | | temperature | voltage | temperature |
| | [g/cm³] | [%] | Permeability | [%] | [V/μm] | [° C.] |
| Example 11 | 5.26 | 4.54 | 38.9 | 20.14 | 24.14 | 980 |
| Example 12 | 5.28 | 5.25 | 40.2 | 20.90 | 24.35 | 900 |
| Example 13 | 5.16 | 4.58 | 40.2 | 22.87 | 24.39 | 900 |
| Example 3 | 5.05 | 5.13 | 45.2 | 22.87 | 24.26 | 900 |
| Example 14 | 5.01 | 4.95 | 41.0 | 26.14 | 23.81 | 900 |
| Example 15 | 5.10 | 5.13 | 42.1 | 29.43 | 24.14 | 980 |

### Evaluation 3

According to the results shown in Table 3, it was confirmed that, provided that the iron oxide content as the main component was within a predetermined range, satisfaction of the predetermined range of the area ratio of the main phases to the grain boundary phase improved the balance among density, porosity, permeability, temperature characteristics of permeability, and withstand voltage characteristics. It was also confirmed that the predetermined range of the iron oxide content as the main component was preferably 24.0 to 50.0 mol % or was more preferably 26.0 to 49.8 mol % in terms of Fe₂O₃.

### Examples 16 to 19

Samples were manufactured as in Example 3 except that the mixing ratio of the raw materials was controlled so that the proportions of the raw materials of the main component were as shown in Table 4. The resultant samples were subject to evaluation as in Example 1. Table 4 shows the results.

TABLE 4

| | | | | | | | | | | Area | |
|---|---|---|---|---|---|---|---|---|---|---|---|
| | | | | | | | | | Average | ratio [%] | |
| | Main component | | | | Subcomponent | | | | grain | | Grain |
| | [mol %] | | | | [parts by weight] | | | | size | Main | boundary |
| | Fe₂O₃ | NiO | CuO | ZnO | SiO₂ | Bi₂O₃ | Co₃O₄ | Ag₂O | [μm] | phase | phase |
| Example 16 | 48.0 | 29.5 | 2.2 | 20.3 | 0.24 | 0.50 | 0.75 | 0.10 | 0.40 | 96 | 4 |
| Example 17 | 48.0 | 26.7 | 5.0 | 20.3 | 0.24 | 0.50 | 0.75 | 0.10 | 0.41 | 96 | 4 |
| Example 3 | 48.0 | 23.5 | 8.2 | 20.3 | 0.24 | 0.50 | 0.75 | 0.10 | 0.403 | 96 | 4 |
| Example 18 | 48.0 | 21.7 | 10.0 | 20.3 | 0.24 | 0.50 | 0.75 | 0.10 | 0.42 | 96 | 4 |
| Example 19 | 48.0 | 19.7 | 12.0 | 20.3 | 0.24 | 0.50 | 0.75 | 0.10 | 0.43 | 96 | 4 |

| | | | | Breakdown | Specific | Firing |
|---|---|---|---|---|---|---|
| | Density | Porosity | | voltage | resistance | temperature |
| | [g/cm³] | [%] | Permeability | [V/μm] | [Ω · m] | [° C.] |
| Example 16 | 4.42 | 5.78 | 39.3 | 23.27 | 2.36E+04 | 900 |
| Example 17 | 4.83 | 5.32 | 41.9 | 23.97 | 1.35E+06 | 900 |
| Example 3 | 5.05 | 5.13 | 45.2 | 24.26 | 1.40E+06 | 900 |
| Example 18 | 5.03 | 4.71 | 43.2 | 23.13 | 2.76E+06 | 900 |
| Example 19 | 4.87 | 5.14 | 40.3 | 23.14 | 1.92E+05 | 900 |

### Evaluation 4

According to the results shown in Table 4, it was confirmed that, provided that the copper oxide content as the main component was within a predetermined range, satisfaction of the predetermined range of the area ratio of the main phases to the grain boundary phase improved the balance among density, porosity, permeability, temperature characteristics of permeability, withstand voltage characteristics, and specific resistance. It was also confirmed that the predetermined range of the copper oxide content as the main component was preferably 2.2 to 12.0 mol % or was more preferably 5.0 to 10.0 mol % in terms of CuO.

### Examples 20 to 23

Samples were manufactured as in Example 3 except that the mixing ratio of the raw materials was controlled so that the proportions of the raw materials of the main component were as shown in Table 5. The resultant samples were subject to evaluation as in Example 1. Table 5 shows the results.

TABLE 5

| | | | | | | | | | | Area | |
|---|---|---|---|---|---|---|---|---|---|---|---|
| | | | | | | | | | Average | ratio [%] | |
| | Main component | | | | Subcomponent | | | | grain | | Grain |
| | [mol %] | | | | [parts by weight] | | | | size | Main | boundary |
| | Fe₂O₃ | NiO | CuO | ZnO | SiO₂ | Bi₂O₃ | Co₃O₄ | Ag₂O | [μm] | phase | phase |
| Example 20 | 48.0 | 31.5 | 8.2 | 12.3 | 0.24 | 0.50 | 0.75 | 0.10 | 0.40 | 96 | 4 |
| Example 21 | 48.0 | 30.8 | 8.2 | 13.0 | 0.24 | 0.50 | 0.75 | 0.10 | 0.41 | 96 | 4 |
| Example 3 | 48.0 | 23.5 | 8.2 | 20.3 | 0.24 | 0.50 | 0.75 | 0.10 | 0.40 | 96 | 4 |
| Example 22 | 48.0 | 5.9 | 8.2 | 37.9 | 0.24 | 0.50 | 0.75 | 0.10 | 0.42 | 96 | 4 |
| Example 23 | 48.0 | 4.8 | 8.2 | 39.0 | 0.24 | 0.50 | 0.75 | 0.10 | 0.40 | 96 | 4 |

| | | | | Breakdown | Specific | Firing |
|---|---|---|---|---|---|---|
| | Density | Porosity | | voltage | resistance | temperature |
| | [g/cm³] | [%] | Permeability | [V/μm] | [Ω · m] | [° C.] |
| Example 20 | 4.99 | 5.12 | 41.6 | 22.29 | 6.57E+05 | 900 |
| Example 21 | 4.95 | 4.92 | 42.4 | 24.28 | 1.02E+06 | 900 |
| Example 3 | 5.05 | 5.13 | 45.2 | 24.26 | 1.40E+06 | 900 |
| Example 22 | 5.07 | 5.01 | 40.2 | 23.63 | 3.77E+06 | 900 |
| Example 23 | 5.19 | 4.14 | 39.1 | 21.14 | 3.41E+06 | 900 |

### Evaluation 5

According to the results shown in Table 5, it was confirmed that, provided that the zinc oxide content as the main component was within a predetermined range, satisfaction of the predetermined range of the area ratio of the main phases to the grain boundary phase improved the balance among density, porosity, permeability, temperature characteristics of permeability, withstand voltage characteristics, and specific resistance. It was also confirmed that the predetermined range of the zinc oxide content as the main component was preferably 12.3 to 39.0 mol % or was more preferably 13.0 to 37.9 mol % in terms of ZnO.

### Examples 24 to 27

Samples were manufactured as in Example 3 except that the mixing ratio of the raw materials was controlled so that the proportions of the raw materials of the subcomponent were as shown in Table 6. The resultant samples were subject to evaluation as in Example 1. Table 6 shows the results.

TABLE 6

| | | | | | | | | | | Area | |
|---|---|---|---|---|---|---|---|---|---|---|---|
| | | | | | | | | | Average | ratio [%] | |
| | Main component | | | | Subcomponent | | | | grain | | Grain |
| | [mol %] | | | | [parts by weight] | | | | size | Main | boundary |
| | Fe₂O₃ | NiO | CuO | ZnO | SiO₂ | Bi₂O₃ | Co₃O₄ | Ag₂O | [μm] | phase | phase |
| Example 24 | 48.0 | 23.5 | 8.2 | 20.3 | 0.02 | 0.50 | 0.75 | 0.10 | 0.43 | 96 | 4 |
| Example 25 | 48.0 | 23.5 | 8.2 | 20.3 | 0.10 | 0.50 | 0.75 | 0.10 | 0.40 | 96 | 4 |
| Example 3 | 48.0 | 23.5 | 8.2 | 20.3 | 0.24 | 0.50 | 0.75 | 0.10 | 0.40 | 96 | 4 |
| Example 26 | 48.0 | 23.5 | 8.2 | 20.3 | 2.00 | 0.50 | 0.75 | 0.10 | 0.39 | 96 | 4 |
| Example 27 | 48.0 | 23.5 | 8.2 | 20.3 | 2.30 | 0.50 | 0.75 | 0.10 | 0.27 | 96 | 4 |

| | | | | Breakdown | Specific | Firing |
|---|---|---|---|---|---|---|
| | Density | Porosity | | voltage | resistance | temperature |
| | [g/cm³] | [%] | Permeability | [V/μm] | [Ω · m] | [° C.] |
| Example 24 | 5.03 | 6.28 | 59.1 | 22.27 | 2.47E+04 | 880 |
| Example 25 | 5.07 | 5.93 | 51.1 | 24.28 | 1.92E+06 | 900 |
| Example 3 | 5.05 | 5.13 | 45.2 | 24.26 | 1.40E+06 | 900 |
| Example 26 | 4.73 | 5.78 | 42.4 | 23.63 | 1.35E+07 | 900 |
| Example 27 | 4.81 | 8.14 | 38.2 | 21.14 | 1.35E+04 | 940 |

### Evaluation 6

According to the results shown in Table 6, it was confirmed that satisfaction of the predetermined range of the area ratio of the main phases to the grain boundary phase improved the balance among density, porosity, permeability, temperature characteristics of permeability, withstand voltage characteristics, and specific resistance when the silicon oxide content as the subcomponent was, with respect to 100 parts by weight main component, preferably 0.02 to 3.0 parts by weight, more preferably 0.1 to 3.0 parts by weight, or still more preferably 0.1 to 2.0 parts by weight in terms of SiO₂.

### Examples 28 to 31

Samples were manufactured as in Example 3 except that the mixing ratio of the raw materials was controlled so that the proportions of the raw materials of the subcomponent were as shown in Table 7. The resultant samples were subject to evaluation as in Example 1. Table 7 shows the results.

TABLE 7

| | | | | | | | | | | Area | |
|---|---|---|---|---|---|---|---|---|---|---|---|
| | | | | | | | | | Average | ratio [%] | |
| | Main component | | | | Subcomponent | | | | grain | | Grain |
| | [mol %] | | | | [parts by weight] | | | | size | Main | boundary |
| | Fe₂O₃ | NiO | CuO | ZnO | SiO₂ | Bi₂O₃ | Co₃O₄ | Ag₂O | [μm] | phase | phase |
| Example 28 | 48.0 | 23.5 | 8.2 | 20.3 | 0.24 | 0.02 | 0.75 | 0.10 | 0.42 | 99 | 1 |
| Example 29 | 48.0 | 23.5 | 8.2 | 20.3 | 0.24 | 0.10 | 0.75 | 0.10 | 0.47 | 99 | 1 |
| Example 3 | 48.0 | 23.5 | 8.2 | 20.3 | 0.24 | 0.50 | 0.75 | 0.10 | 0.40 | 96 | 4 |
| Example 30 | 48.0 | 23.5 | 8.2 | 20.3 | 0.24 | 2.00 | 0.75 | 0.10 | 0.35 | 94 | 6 |
| Example 31 | 48.0 | 23.5 | 8.2 | 20.3 | 0.24 | 3.00 | 0.75 | 0.10 | 1.73 | 92 | 8 |

| | | | | Breakdown | Specific | Firing |
|---|---|---|---|---|---|---|
| | Density | Porosity | | voltage | resistance | temperature |
| | [g/cm³] | [%] | Permeability | [V/μm] | [Ω · m] | [° C.] |
| Example 28 | 4.85 | 7.13 | 35.2 | 22.29 | 5.07E+04 | 940 |
| Example 29 | 4.78 | 5.28 | 41.2 | 24.28 | 1.91E+06 | 900 |
| Example 3 | 5.05 | 5.13 | 45.2 | 24.26 | 1.40E+06 | 900 |
| Example 30 | 5.16 | 4.19 | 49.1 | 23.63 | 2.39E+06 | 900 |
| Example 31 | 5.16 | 4.87 | 68.4 | 24.14 | 4.24E+04 | 880 |

### Evaluation 7

According to the results shown in Table 7, it was confirmed that satisfaction of the predetermined range of the area ratio of the main phases to the grain boundary phase improved the balance among density, porosity, permeability, temperature characteristics of permeability, withstand voltage characteristics, and specific resistance when the bismuth oxide content as the subcomponent was preferably 0.02 to 3.0 parts by weight or more preferably 0.10 to 2.0 parts by weight in terms of Bi₂O₃.

### Examples 32 to 36

Samples were manufactured as in Example 3 except that the mixing ratio of the raw materials was controlled so that the proportions of the raw materials of the subcomponent were as shown in Table 8. The resultant samples were subject to evaluation as in Example 1. Table 8 shows the results.

TABLE 8

| | | | | | | | | | | Area | |
|---|---|---|---|---|---|---|---|---|---|---|---|
| | | | | | | | | | Average | ratio [%] | |
| | Main component | | | | Subcomponent | | | | grain | | Grain |
| | [mol %] | | | | [parts by weight] | | | | size | Main | boundary |
| | Fe₂O₃ | NiO | CuO | ZnO | SiO₂ | Bi₂O₃ | Co₃O₄ | Ag₂O | [μm] | phase | phase |
| Example 32 | 48.0 | 23.5 | 8.2 | 20.3 | 0.24 | 0.50 | 0.00 | 0.10 | 0.42 | 96 | 4 |
| Example 33 | 48.0 | 23.5 | 8.2 | 20.3 | 0.24 | 0.50 | 0.10 | 0.10 | 0.41 | 96 | 4 |
| Example 3 | 48.0 | 23.5 | 8.2 | 20.3 | 0.24 | 0.50 | 0.75 | 0.10 | 0.40 | 96 | 4 |
| Example 34 | 48.0 | 23.5 | 8.2 | 20.3 | 0.24 | 0.50 | 1.00 | 0.10 | 0.41 | 96 | 4 |
| Example 35 | 48.0 | 23.5 | 8.2 | 20.3 | 0.24 | 0.50 | 3.00 | 0.10 | 0.42 | 96 | 4 |
| Example 36 | 48.0 | 23.5 | 8.2 | 20.3 | 0.24 | 0.50 | 4.00 | 0.10 | 0.41 | 96 | 4 |

| | | | | Breakdown | Specific | Firing |
|---|---|---|---|---|---|---|
| | Density | Porosity | | voltage | resistance | temperature |
| | [g/cm³] | [%] | Permeability | [V/μm] | [Ω · m] | [° C.] |
| Example 32 | 4.89 | 5.25 | 45.1 | 23.28 | 3.21E+05 | 900 |
| Example 33 | 4.73 | 6.15 | 44.7 | 24.13 | 1.67E+06 | 900 |
| Example 3 | 5.05 | 5.13 | 45.2 | 24.26 | 1.40E+06 | 900 |
| Example 34 | 4.79 | 6.69 | 43.0 | 23.59 | 1.39E+06 | 900 |
| Example 35 | 4.83 | 6.15 | 40.4 | 24.14 | 1.01E+06 | 900 |
| Example 36 | 5.10 | 5.86 | 38.4 | 23.42 | 4.24E+06 | 900 |

### Evaluation 8

According to the results shown in Table 8, it was confirmed that satisfaction of the predetermined range of the area ratio of the main phases to the grain boundary phase made the cobalt oxide unnecessary as the subcomponent. However, the cobalt oxide was preferably contained; and it was confirmed that the balance among density, porosity, permeability, temperature characteristics of permeability, withstand voltage characteristics, and specific resistance was improved when the cobalt oxide content was preferably 0.1 to 4.0 parts by weight or more preferably 0.1 to 3.0 parts by weight in terms of Co₃O₄.

### Examples 37 to 41

Samples were manufactured as in Example 3 except that the mixing ratio of the raw materials was controlled so that the proportions of the raw materials of the subcomponent were as shown in Table 9. The resultant samples were subject to evaluation as in Example 1. Table 9 shows the results.

TABLE 9

| | | | | | | | | | | Area | |
|---|---|---|---|---|---|---|---|---|---|---|---|
| | | | | | | | | | Average | ratio [%] | |
| | Main component | | | | Subcomponent | | | | grain | | Grain |
| | [mol %] | | | | [parts by weight] | | | | size | Main | boundary |
| | Fe₂O₃ | NiO | CuO | ZnO | SiO₂ | Bi₂O₃ | Co₃O₄ | Ag₂O | [μm] | phase | phase |
| Example 37 | 48.0 | 23.5 | 8.2 | 20.3 | 0.24 | 0.50 | 0.75 | 0.00 | 0.41 | 96 | 4 |
| Example 38 | 48.0 | 23.5 | 8.2 | 20.3 | 0.24 | 0.32 | 0.75 | 0.02 | 0.41 | 96 | 4 |
| Example 39 | 48.0 | 23.5 | 8.2 | 20.3 | 0.24 | 0.22 | 0.75 | 1.20 | 0.40 | 96 | 4 |
| Example 40 | 48.0 | 23.5 | 8.2 | 20.3 | 0.24 | 0.10 | 0.75 | 3.00 | 0.42 | 96 | 4 |
| Example 41 | 48.0 | 23.5 | 8.2 | 20.3 | 0.24 | 0.10 | 0.75 | 3.20 | 0.40 | 96 | 4 |

| | | | | Breakdown | Specific | Firing |
|---|---|---|---|---|---|---|
| | Density | Porosity | | voltage | resistance | temperature |
| | [g/cm³] | [%] | Permeability | [V/μm] | [Ω · m] | [° C.] |
| Example 37 | 4.60 | 11.01 | 52.2 | 16.14 | 3.42E+06 | 900 |
| Example 38 | 4.88 | 6.91 | 49.2 | 24.27 | 1.39E+06 | 900 |
| Example 39 | 4.82 | 7.28 | 47.1 | 25.97 | 2.15E+06 | 880 |
| Example 40 | 4.86 | 7.21 | 40.9 | 24.25 | 1.92E+06 | 860 |
| Example 41 | 5.02 | 4.33 | 38.1 | 25.76 | 5.19E+05 | 860 |

### Evaluation 9

According to the results shown in Table 9, it was confirmed that satisfaction of the predetermined range of the area ratio of the main phases to the grain boundary phase made the silver oxide unnecessary as the subcomponent. However, the silver oxide was preferably contained; and it was confirmed that the balance among density, porosity, permeability, temperature characteristics of permeability, withstand voltage characteristics, and specific resistance was improved when the silver oxide content was preferably 0.02 to 3.2 parts by weight, more preferably 0.02 to 3.0 parts by weight, or 0.1 to 3.0 parts by weight with other tables being considered, in terms of Ag₂O.

### REFERENCE NUMERALS

1, 1a . . . multilayer chip coil
2 . . . magnetic layer
3, 3a . . . internal electrode layer
4, 4a . . . chip body
5 . . . terminal electrode
6 . . . terminal connecting through-hole electrode
6a . . . leading electrode
12 . . . main phase (spinel ferrite phase)
16 . . . grain boundary phase
30, 30a . . . coil conductor

What is claimed is:

1. A multilayer coil device comprising:
a magnetic layer,
wherein
the magnetic layer comprises main phases and a grain boundary phase, the main phases comprising a spinel ferrite, the grain boundary phase comprising a silicon oxide and a bismuth oxide; and
the main phases and the grain boundary phase have an area ratio of 92:8 to 99:1.

2. The multilayer coil device according to claim 1, wherein
the magnetic layer comprises a ferrite composition comprising a main component and a subcomponent;
the main component comprises 24.0 to 50.0 mol % iron oxide in terms of Fe₂O₃, 2.2 to 12.0 mol % copper oxide in terms of CuO, 12.3 to 39.0 mol % zinc oxide in terms of ZnO, and a nickel oxide as a remainder; and
the subcomponent comprises 0.02 to 3.0 parts by weight bismuth oxide in terms of Bi₂O₃ with respect to 100 parts by weight of the main component.

3. The multilayer coil device according to claim 1, wherein the subcomponent comprises 0.02 to 3.0 parts by weight silicon oxide in terms of SiO₂ with respect to 100 parts by weight of the main component.

4. The multilayer coil device according to claim 1, wherein the subcomponent comprises 0.1 to 4.0 parts by weight cobalt oxide in terms of Co₃O₄ with respect to 100 parts by weight of the main component.

5. The multilayer coil device according to claim 1, wherein the subcomponent comprises 0.02 to 3.2 parts by weight silver oxide in terms of Ag₂O with respect to 100 parts by weight of the main component.

6. The multilayer coil device according to claim 1, wherein the main phases have an average grain size of 0.27 to 0.6 μm.
